(19) United States
(12) Patent Application Publication
(10) Pub. No.: US 2006/0123592 A1
(43) Pub. Date: Jun. 15, 2006

(54) Adjustable hinge for a motor vehicle

(76) Inventor: Johnnie Yip, La Puente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/014,022

(22) Filed: Dec. 15, 2004

(51) Int. Cl. E05D 7/06

(52) U.S. Cl. 16/241

(57) ABSTRACT

A motor vehicle has an adjustable door hinge assembly that allows movement of a door of the vehicle in one or more directions. In one arrangement, the door can be rotated about a first axis from a closed position to a partially opened position. The door can be rotate about a second axis from the partially opened position to a fully opened position. When the door is in the fully opened position, a person can easily ingress or egress the motor vehicle. The adjustable door hinge assembly can have one or more adjustment assemblies that can be used to determine the position of the door when the door is in the closed position, partially opened, fully opened position, and/or any position therebetween.

### BACKGROUND OF THE INVENTION

1. Field of the Invention

The present inventions are directed to hinges for a motor vehicle and, more particularly, to adjustable hinges for scissor-type opening doors.

2. Description of the Related Art

Motor vehicles, such as automobiles, typically have a door that rotates horizontally about a hinge for passenger ingress and egress. Typically, a portion of the hinge is mounted to the frame or a reinforced portion of the automobile body and another portion of the hinge is mounted to the door. When using such a hinge, there must be adequate space between the vehicle and an adjacent vehicle, such that the vehicle's door can swing in a horizontal plane about the hinge. Unfortunately, many times parking lots have relatively narrow parking spaces (e.g., compact parking spaces). When an automobile parked in this type of parking space is flanked by relatively wide automobiles, a person may have difficulty opening the vehicle door to a position suitable for convenient ingress and/or egress.

The Lamborghini® company, with its original Countach® sports car, made famous the scissor-type opening car door. For decades, the Countach®D was virtually the only automobile available in the world with scissor-type opening doors.

Recently, aftermarket suppliers have developed retrofit kits including a replacement hinge, for converting a conventional automobile door into a scissor-type door. In order to achieve the scissor movement, the retrofit hinges allow a conventional automobile door to first move outwardly away from the body of the automobile, in a generally horizontal direction, to a partially open position. With the door in the partially open position, it is then allowed to pivot upwardly in the scissor-type manner. As such, conventionally-opening automobile doors can be provided with a modified scissor-opening movement.

### SUMMARY OF THE INVENTION

An aspect of at least one of the inventions disclosed herein includes the realization that after a retrofit hinge is installed, the bolts used to hold the hinge in place might allow the door to shift over time. Additionally, the hinge itself might bend over time, thereby affecting the alignment of the door. Thus, a significant advantage is achieved by constructing such a hinge such that it can be easily adjusted, without the need to remove body panels from the vehicle.

In accordance with one embodiment, a hinge for a motor vehicle comprises a mounting bracket configured to be mounted to a portion of motor vehicle that remains stationary relative to a door of the vehicle. A door arm is configured to be mounted to the door of the motor vehicle. A housing connects the door arm to the fender bracket and defines a first pivot axis and a second pivot axis. A first adjustment member is received within and is movable relative to the housing and is configured to limit the rotation of the door arm about the second pivot axis towards the fender bracket. Additionally, a second adjustment member is movable relative to the housing and has a first end configured to contact the fender bracket when the door arm is rotated about the first pivot axis through a predetermined angle relative to the fender bracket, wherein the second adjustment member has an opposing second end extending generally towards the door arm, the second end being exposed to an exterior of the housing.

In accordance with another embodiment, a hinge for a motor vehicle comprises a fender bracket configured to be mounted to a portion of a motor vehicle adjacent to a door opening of the motor vehicle. A door arm is configured to be mounted a door of a motor vehicle. A hinge assembly connects the door arm to the fender bracket. The hinge assembly defines a first pivot axis and a second pivot axis. The hinge assembly and the door arm are connected such that the door arm can rotate about the first pivot axis between a first position and a second position, and about the second pivot axis relative to the housing between a third position and a fourth position. A first adjustment assembly is configured to selectively determine at least the maximum limit of the angle between the first position and the second position. Additionally, a second adjustment assembly is configured to selectively determine the maximum limit of the angle between the third position and the fourth position.

In accordance with yet another embodiment, a hinge for a motor vehicle comprises a fender bracket configured to be mounted to a portion of a motor vehicle adjacent to a door opening of the motor vehicle. A door arm is configured to be mounted the door of the motor vehicle. A hinge assembly connects the door arm to the fender bracket, the hinge assembly defining a first pivot axis and a second pivot axis. The hinge assembly and the door arm are connected such that the door arm can rotate about the first pivot axis between a first position and a second position, and about the second pivot axis relative to the housing between a third position and a fourth position. Additionally, the hinge includes means for selectively determining the maximum limit of the angle between the first position and the second position and the maximum limit of the angle between the third position and the fourth position.

### BRIEF DESCRIPTION OF THE DRAWINGS

FIG. 1 is a perspective view of a prior art automobile.

FIG. 2 is a perspective view of the automobile of FIG. 1 with a driver's door in a partially open position.

FIG. 3 is a perspective view of the automobile of FIG. 1 with the driver's door in a fully opened position.

FIG. 4 is a side elevational view of a known hinge of the automobile of FIG. 1.

FIG. 4A is a cross-sectional view of the hinge assembly of FIG. 4 taken along the line 4A-4A when the hinge assembly is in a first position.

FIG. 4B is a cross-sectional view of the hinge assembly of FIG. 4 taken along the line 4B-4B when the hinge assembly is in a second position. Features and advantages of the inventions will be more apparent upon reading the following detailed description and with a reference to the accompanying drawings of embodiments that exemplify the inventions, in which:

FIG. 5 is a side elevational view of an automobile having an adjustable scissor-type hinge assembly for an automobile door in accordance with one embodiment.

FIG. 6 is a perspective view of the automobile of FIG. 5 having a door in a partially opened position.

FIG. 7 is a side elevational view of the adjustable hinge assembly of FIG. 5.

FIG. 8 is a top elevational view of the adjustable hinge assembly of FIG. 7 in a closed position.

FIG. 9 is a top elevational view of the adjustable hinge assembly of FIG. 7 in a partially opened position.

FIG. 9A is a top elevation view of the adjustable hinge assembly of FIG. 7 illustrating an angle of adjustment.

FIG. 10 is a side elevational view of the adjustable hinge assembly of FIG. 7 in a fully opened position.

FIG. 11 is an enlarged side elevational view of the adjustable hinge assembly of FIG. 7 identified by line 11-11.

FIG. 12 is a side elevational view of the housing of the adjustable hinge assembly of FIG. 7.

FIG. 13 is a cross-sectional view of the adjustment hinge assembly of FIG. 7 taken along the line 13-13, the adjustable hinge assembly is connected to a fender.

FIG. 14 is a back elevational view of a housing of the adjustment hinge assembly of FIG. 7.

### DETAILED DESCRIPTION OF THE PREFERRED EMBODIMENTS

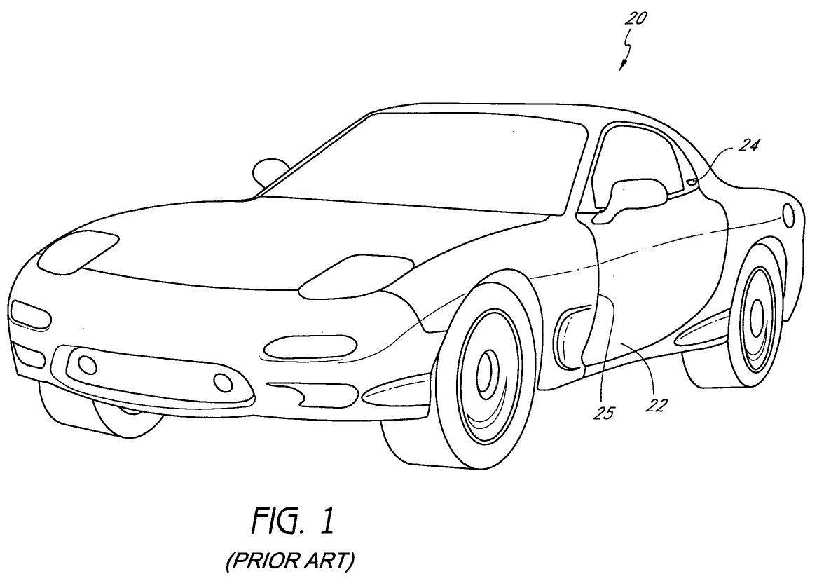

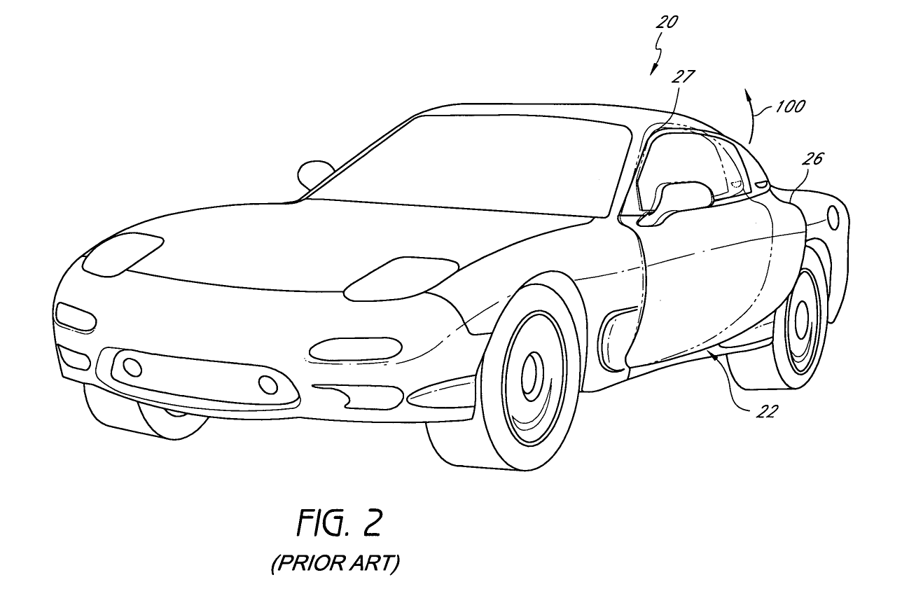

With reference to FIG. 1, an overall configuration of an automobile 20 with a prior art scissor-type door hinge assembly is described to assist the reader's understanding of a preferred embodiment of use of the present inventions. However, one of ordinary skill in the art will appreciate that the present inventions can also be used in other environments, including other vehicles and buildings.

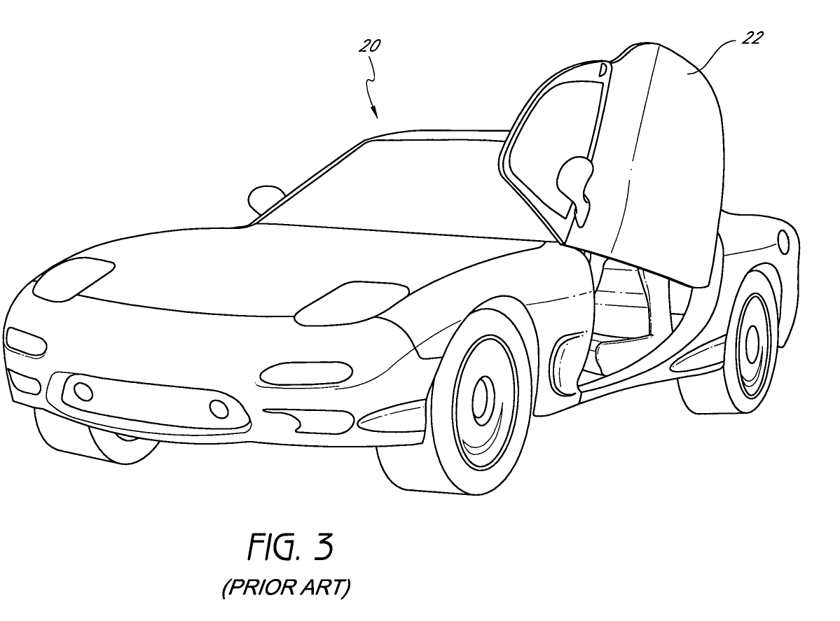

Generally, the automobile 20 has an automobile door 22 that can be opened by operating the handle 24. A forward portion 25 of the door 22 is hingedly connected to the fender of the automobile 20 with a scissor-type hinge assembly. As such, the door 22 can be rotated outwardly in a horizontal plane from a closed position to a partially opened position illustrated in FIG. 2.

When the door 22 is in the partially opened position, a rearward portion 26 of the door 22 is spaced from a door opening 27. The door 22 can then be rotated upwardly and forwardly to the fully opened position illustrated in FIG. 3. When the door 22 is in the fully opened position, a person can easily ingress and/or egress the automobile 20, even if a vehicle is adjacent to the door 22. Thus, the door 22 can be opened and closed to allow a passenger to enter and/or exit the automobile 20, even when the automobile 20 is located in a parking space that is too narrow for opening and closing a traditional automobile door.

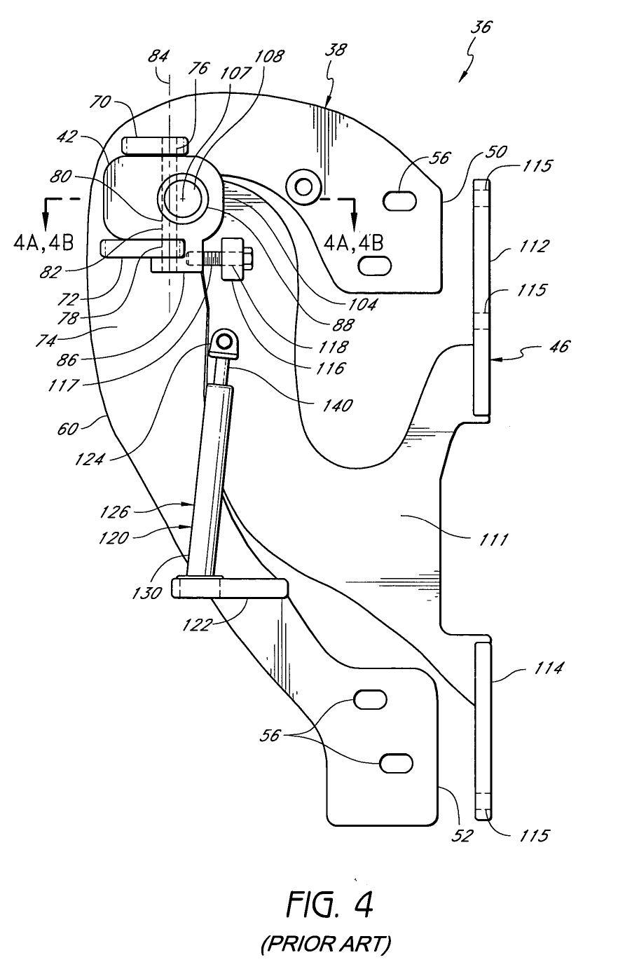

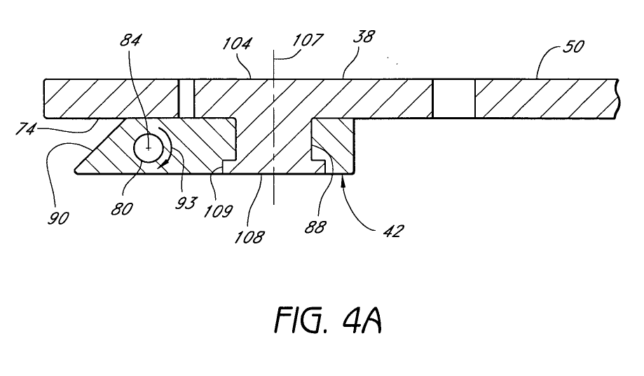

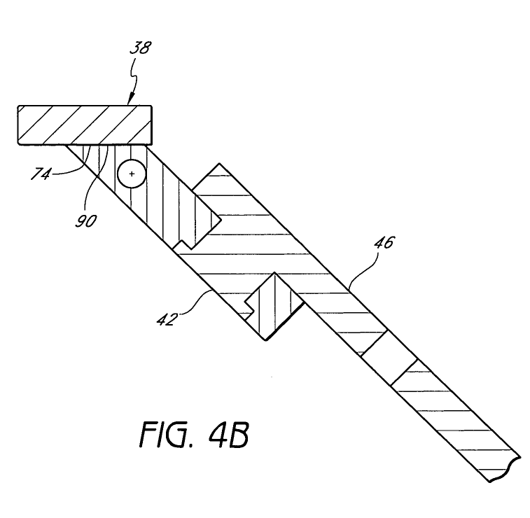

The automobile 20 can have a hinge similar to a hinge assembly 36 illustrated in FIG. 4. The known hinge assembly 36 is coupled to either the frame or a reinforced portion of the automobile 20 as well as the forward portion 25 of the door 22. The hinge assembly 36 includes a fender bracket 38, a pivot plate 42, and a door arm 46. The fender bracket 38 is rigidly mounted to a portion of the frame or a reinforced portion of the body automobile 20 beneath the fender. The door arm 46 is rigidly mounted to the automobile door 22. The pivot plate 42 defines two axes of rotation.

The fender bracket 38 comprises an upper mounting plate 50 and a lower mounting plate 52, each having a plurality of apertures 56 configured to receive a fastener for mounting the fender bracket 38 to the automobile 20. A fender bracket body portion 60 extends between the upper mounting plate 50 and the lower mounting plate 52.

The fender body portion 60 also comprises an upper support 70 and a lower support 72. The illustrated upper support 70 and lower support 72 are extend outwardly from a surface 74 of the fender body portion 60. The pivot plate 42 is rotatably connected to the supports 70, 72 by a pin 80 held by generally coaxial holes 76, 78 located in the supports 70, 72, respectively. The pin 80 defines a generally vertical pivot axis 84, when the hinge 36 is mounted to an automobile. The pivot axis 84 allows the door 22 to move in a generally horizontal direction as the initial phase of opening.

The upper end of the pin 80 is rotabably held by the upper support 70. A lower portion of the pin 80 extends through the lower support 72 and a passage in an L- shaped portion 86 of the pivot plate 42. The central portion of the pin 80 is disposed through a through-hole 82 of the pivot plate 42 such that the pivot plate 42 and the door arm 46 can rotate together about a generally vertical axis 84.

The door arm 46 is rotatably mounted to the pivot plate 42. As shown in FIGS. 4 and 4A, the pivot plate 42 comprises a generally horizontal through-hole 88 defining a generally horizontal axis 107 (when the hinge 36 is mounted to an automobile). As shown in FIG. 4A, the through-hole 88 preferably has a counterbore 109 for receiving a head of a door arm pin 108.

The door arm 46 also includes an arm hinge mount 104 that is rigidly coupled to the door arm pin 108, which in turn is disposed within the through-hole 88. The door arm 46 and pin 108 can rotate together about the horizontal axis 107 relative to the pivot plate 42.

The door arm 46 has a curved body 111 that extends from the arm hinge mount 104 to an upper door mount 112 and a lower door mount 114. The curved body 111 can have a door arm adjustment bracket 116 for positioning the door arm 46 relative to the fender bracket 38.

The door arm adjustment bracket 116 has an internally threaded hole 118 configured to engage a threaded bolt 117. The bolt 117 can be rotated relative to the bracket 116 to move the bolt 117 towards or away from the pivot plate 42. The bolt 117 can contact the pivot plate 42 and determine the angular relationship between the pivot plate 42 and the door arm 46. The weight of the door 22 may cause the door arm 46 to rotate downwardly about the horizontal axis 107, until the bolt 117 contacts the pivot plate 42 thereby preventing further downward movement of the door arm 46 and the door 22. Thus, the bolt also provides means for aligning the door 22 with the body of the automobile 20, in the vertical direction.

The upper door mount 112 and the lower door mount 114 are spaced from each other and configured to attach to the door 22. The upper door mount 112 and the lower door mount 114 each comprise plates that have one or more apertures 115. As such, fasteners can extend through the apertures 115 to rigidly couple the door arm 46 to the door 22.

FIG. 4A shows the orientation of the pivot plate 42 when the door 22 is closed. A bevel 90 is disposed on an inner surface of the pivot plate 42 and is spaced from the surface 74 of the fender body portion 60. When the door 22 is opened, the door arm 46 and door 22 can be rotated in a generally horizontal direction about the axis 84, in the direction indicated by the arrow 93.

With reference to FIG. 4B, when the door 22 is rotated about the axis 84 to a predetermined position, the bevel 90 contacts the surface 74, so as to stop any further horizontal movement of the door 22. When the bevel 90 contacts the surface 74, the automobile door 22 is in the partially opened position (FIG. 2). The automobile door 22 can then be rotated upwardly and forwardly about the horizontal axis 107 in the direction indicated by the arrow 100 (FIG. 2) from the partially opened position to the fully opened position. When closing, the door 22 can be moved from the fully opened position (FIG. 3) to the partially opened position (FIG. 2) and then moved to the closed position (FIG. 4).

The hinge assembly 36 can have a mechanism for ensuring that the automobile door 22 remains in an opened position, i.e., until a person pulls down on the door 22. The illustrated hinge assembly 36 of FIG. 4 comprises a shock assembly 120. The shock assembly 120 includes a fender bracket shock mount 122 and a door arm shock mount 124.

The fender bracket shock mount 122 extends outwardly from the fender body portion 60. The door arm shock mount 124 extends outwardly from the door arm 46.

The shock assembly 120 is pivotally connected to and extends between the fender shock mount 122 and the arm shock mount 124. The shock assembly 120 comprises a shock housing 130 that is pivotably mounted to the fender shock mount 122. For example, the shock mount 122 can include an annular bearing that pivotally holds the shock housing 130.

A piston rod assembly 140 is movably disposed within the shock housing 130 and is connected to the arm shock mount 124. The upper end of the piston rod assembly 140 is preferably pivotably connected to the arm shock mount 124. Thus, the shock housing 130 can pivot with respect to the shock mount 122, and the piston rod assembly 140 can pivot with respect to the shock mount 124. As the door arm 46 is rotated upwardly about the horizontal axis 107, the piston rod assembly 140 extends out of the shock housing 130. When the door arm 46 reaches the fully opened position, the shock assembly 120 is configured to maintain the position of the door 22. When the door arm 46 is rotated downwardly about the horizontal axis 107, the shock assembly 120 is compressed until the door 22 reaches the partially closed position.

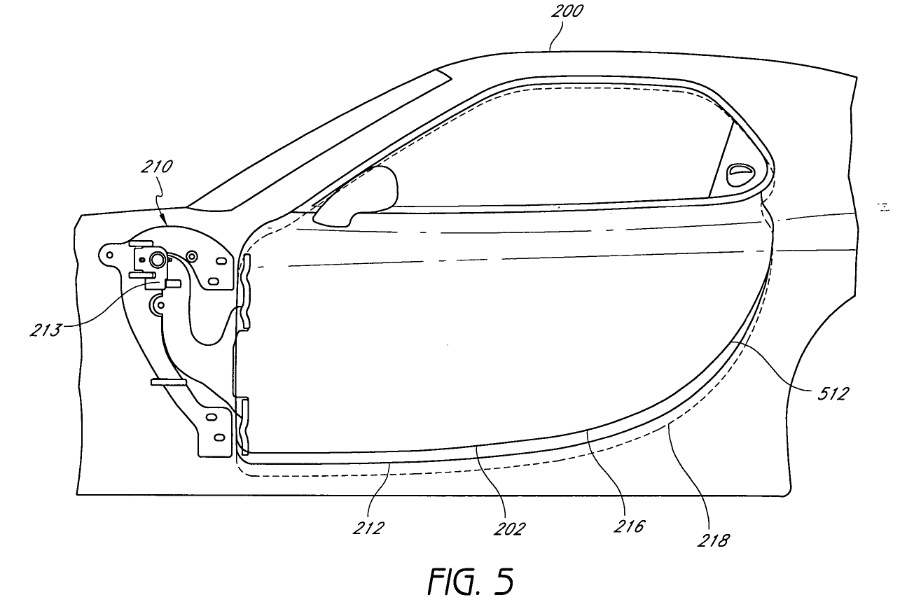

FIG. 5 is a side elevational view of an automobile 200 that has an adjustable hinge assembly 210 constructed in accordance with an embodiment. The hinge assembly 210 is mounted to the automobile 200. Certain portions of the adjustable hinge assembly 210 can be constructed in a manner similar to that of the hinge assembly 36, and thus, the description of those portions is not repeated herein.

Generally, the door 202 is connected to the adjustable hinge assembly 210, which can rotate the door 202 about a plurality of axes. The adjustable hinge assembly 210 has one or more adjustment assemblies for affecting the position of the door 202.

In some embodiments, including the illustrated embodiment, the adjustable hinge assembly 210 includes a first adjustment assembly 213 that can be manipulated to selectively adjust the minimum or lowest height position of the automobile door 202. For example, by manipulating the assembly 213, the minimum height of the door 202 can be raised to a high position 216, a low position 218 (shown in phantom), or any position therebetween.

Thus, the first adjustment assembly 213 can be used to align the door 202 with the door opening 212, e.g., during installation of the adjustable hinge assembly 210. For example, the first adjustment assembly 213 can move the door 202 downwardly from the high position 216 such that the door 202 fits properly within the door opening 212. Alternatively, if the door 202 is in the low position 218, the first adjustment assembly 213 can move upwardly the door 202 to a desired position. Additionally, if the hinge 210 deforms over time, if the bolts holding the hinge 210 in place slip, or if the hinge 210 is deformed or moved by impact, the door 202 can be re-aligned with the door opening 212 by adjusting the assembly 213.

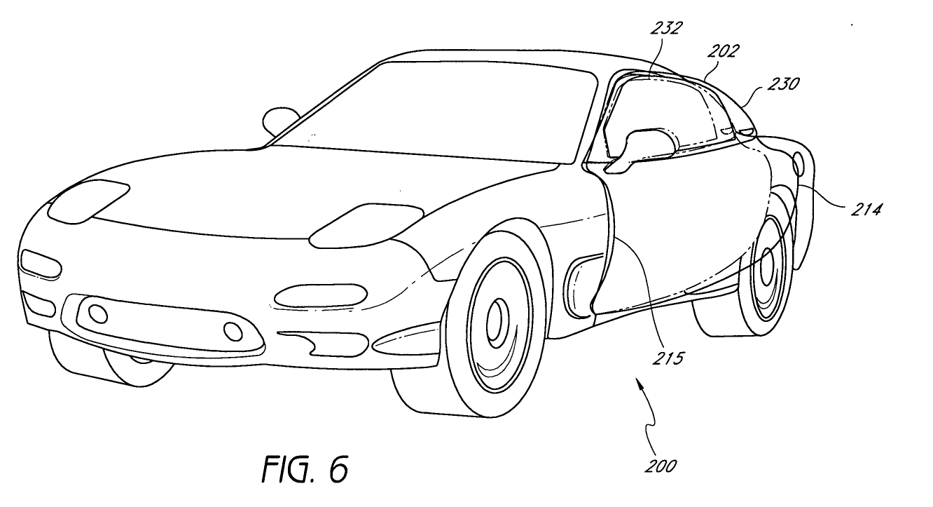

With reference to FIGS. 5 and 6, the adjustable hinge assembly 210 can also include a second adjustment assembly 400 (FIG. 5) that can be manipulated to adjust the maximum outward position of the door 202. For example, as shown in FIG. 56 opens to a first partially opened position 230 (FIG. 6), a second partially opened position 232 (shown in phantom), or any position therebetween. In other words, the second adjustment assembly 400 is configured to determine the angle between door opening 212 and the door 202 in a partially opened position. After the door 202 is in the partially opened position (e.g., one of the first or second partially opened positions 230, 232), the door 202 can be rotated upwardly and forwardly to a fully opened position, as discussed above.

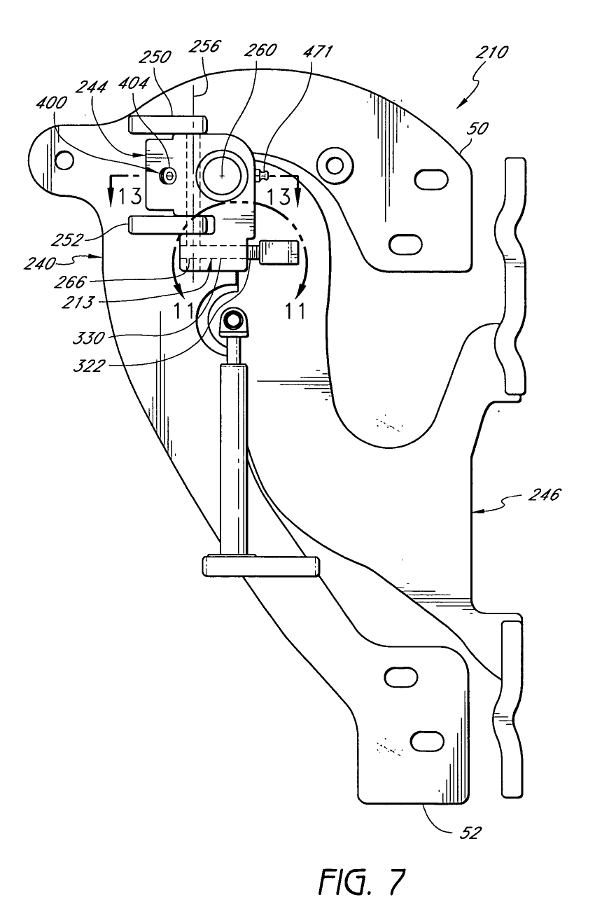

With respect to FIG. 7, the adjustable hinge assembly 210 includes a fender bracket 240, an adjustable housing 244, and a door arm 246. The fender bracket 240 includes an upper support 250 and a lower support 252 that cooperate to rotatably hold the housing 244. The housing 244 can pivot about a first axis 256. The first axis 256 can be a generally vertically orientated axis; however, the first axis 256 can be angled from an imaginary vertical axis, or have any other suitable orientation for the desired movement of the door arm 246.

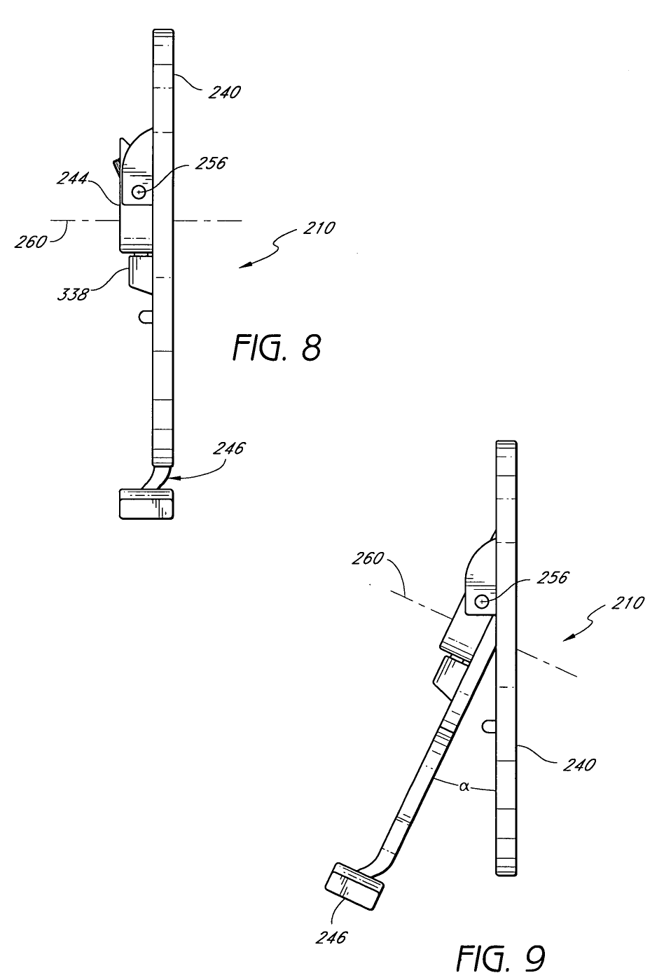

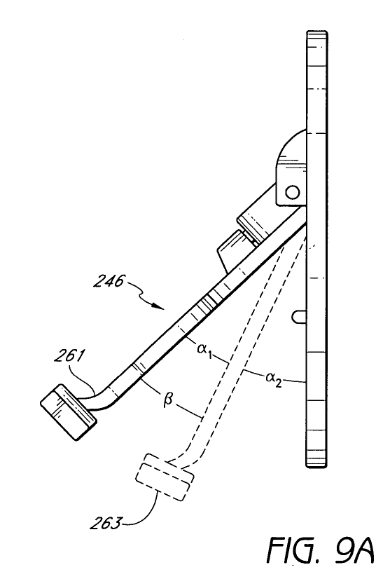

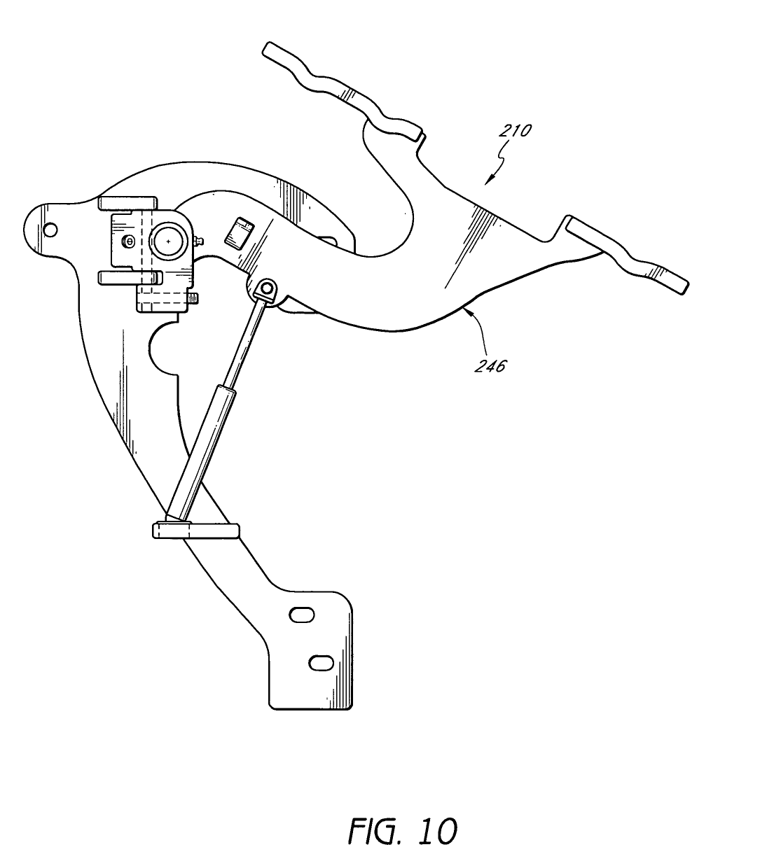

The door arm 246 is pivotably connected to the housing 244. In the illustrated embodiment, the door arm 246 can rotate about the second axis 260 (FIGS. 8 and 9) relative to the housing 244. The second axis 260 can be a generally horizontal axis. In other embodiments, the second axis 260 can be angled to an imaginary horizontal axis, or any other suitable orientation for the desired movement of the door arm 246.

With continued reference to FIG. 7, the first adjustment assembly 213 can comprise a first adjustment member 322 movably disposed within the housing 244. The first adjustment assembly 213 also preferably comprises a hole 330 that extends into the housing 244, and is configured to define the angular relationship about the second axis 260 between the fender bracket 240 and door arm 246.

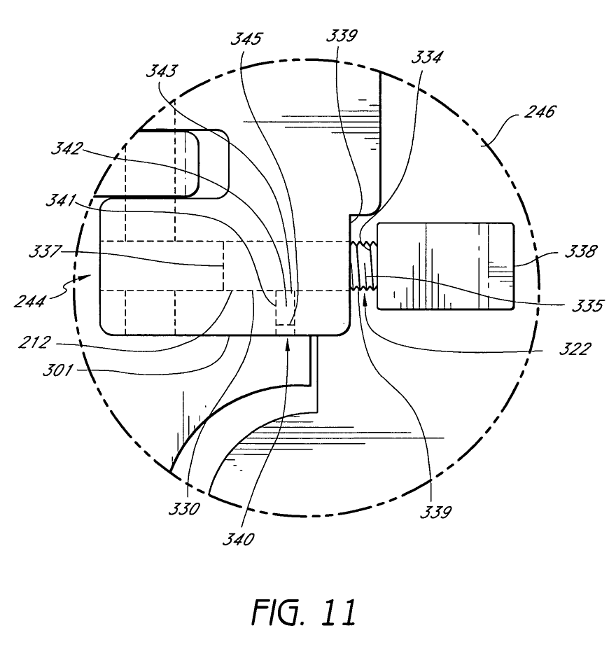

With reference to FIGS. 7 and 11, the first adjustment member 322 can be configured to engage the door arm 246. The adjustment member 322 can be an externally threaded elongated body configured to define a stop 334. The stop 334 can have any shape and can be integral with the member 322. In some embodiments, the stop 334 can simply be an end of the member 322. The member 322, and optionally the stop 334, is arranged to contact a protrusion 338 of the door arm 246.

The adjustment member 322 can be configured to receive a tool. For example, the stop 334 preferably comprises a gripping structure for engaging a tool. Any of a variety of gripping structures may be provided, such as one or more slots, flats, recesses, or the like in the stop 334.

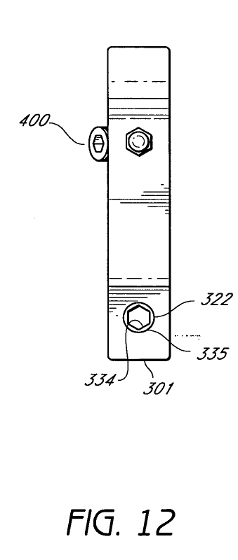

As shown in FIGS. 11 and 12, the illustrated stop 334 includes a gripping structure that can be polygonal (including rounded polygonal), and, in particular, a pentagonal or hexagonal recess 334 such that a similarly shaped and sized tool may engage the recess 334 to impart rotary motion. For example, the hexagonal recess 334 is configured to receive a hexagonal wrench, also known as an “allen wrench” in order to rotate the first adjustment member 322 relative to the housing 244.

A further advantage is provided where the gripping structure 335 is outwardly facing, preferably in the rearward direction, so that a tool can easily engage and rotate the adjustment member 322. When the protrusion 338 is spaced from the stop 334, the gripping structure 335 is conveniently accessible to change the location of the adjustment member 322. For example, when the door 202 is moved upwardly from the partially opened position, a tool can be easily inserted into the gripping structure 335 for imparting rotary motion.

With reference to FIG. 11, at least a portion of the adjustment member 322 is disposed within the hole 330 in the housing 244. The hole 330 is an internally threaded passage that extends through at least a portion of the housing 244. For example, the hole 330 can be a through-hole that is sized to receive a portion 337 of the adjustment member 322.

The longitudinal axis of the hole 330 can be spaced from the lower surface 301 of the housing 244. In some non-limiting embodiments, the longitudinal axis of the illustrated hole-330 is spaced from the surface 301 by a distance of at least about 0.25 inch, 0.33 inch, 0.5 inch, 0.75 inch, and/or ranges encompassing such distances.

The hole 330 can have a length that is greater than the length of the first adjustment member 322. The first adjustment member 322 can be rotated and thus advanced into the hole 330 until the stop 334 is positioned within the hole 330. When the first adjustment member 322 is in this position, the protrusion 338 can contact the surface 339 of the housing 244. Alternatively, the hole 330 can have a length that is similar to or less than the length of the first adjustment member 322. A skilled artisan can select the configuration of the hole 330 and the first adjustment member 322 to achieve the desired range of vertical adjustment θ (e.g., the angle defined between the high position and low position 218 in FIG. 5).

In the illustrated embodiment of FIG. 11, the hole 330 has internal threads that are configured to engage complimentary external threads on the first adjustment member 322. When the door 202 of the automobile 200 is in the closed or partially opened position, the stop 334 can contact the protrusion 338 to ensure that the door 202 is properly aligned with the door opening 212. The length of a portion 339 of first adjustment member 322 interposed between the housing 244 and the door arm 246 can be increased or decreased by rotating the first adjustment member 322 relative to the hole 330.

Optionally, the housing 244 can have a lock assembly 340 to inhibit or prevent movement of the first adjustment member 322. The lock assembly 340 can include an internally threaded passage 341 extending from the hole 330 to the surface 301 of the housing 244. An externally threaded lock member 342 can have an upper end 343 that frictionally interacts with the first adjustment member 322, thereby inhibiting or preventing movement of the first adjustment member 322. A lower end 345 of the lock member 342 can have a gripping structure for rotating the lock member 342. To change the position of the first adjustment member 322, the lock member 342 can be rotated and moved away from the first adjustment member 322. The first adjustment member 322 then can be moved to a desired position. Then the lock member 342 can be rotated and advanced through the hole 341 until the lock member 342 contacts the first adjustment member 322, thereby preventing relative movement between the adjustment member 322 and the housing 244. In some embodiments, the lock member 342 can be in the form of a “set screw”.

Preferably, when the door arm 246 is rotated about the first axis 256 between the closed position and the partially opened position, the stop 334 can generally remain in contact with the portion 338, thereby preventing the door arm 246 from pivoting downwardly about the axis 260. In this manner, the door 202 can swing outwardly along a generally horizontal direction as it moves from the closed position to the partially opened position, with the door arm 246 resting against the stop 334.

With reference to FIG. 7, the second adjustment assembly 400 is configured to limit the distance that the door 202 moves outwardly from the automobile (e.g., the location of the door 202 in the partially opened position). In other words, the adjustment assembly 400 determines the angle a (FIG. 9) defined between the fender bracket 240 and the door arm 246.

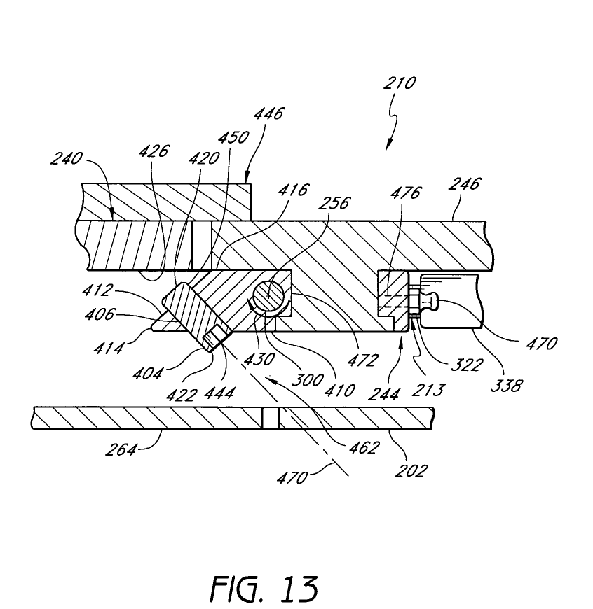

With reference to FIG. 13, the second adjustment assembly 400 can include a second adjustment member 404 and a hole 406 of the housing 244 configured to receive the second adjustment member 404. The second adjustment member 404, in some embodiments, can be similar to the first adjustment member 322.

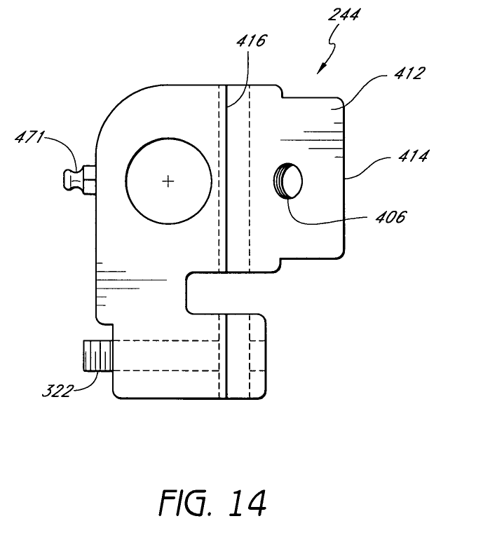

The hole 406 is preferably a through-hole that extends between the outer surface 410 and the bevel 412 of the housing 244. The hole 406 is an internally threaded passage configured to mate with external threads of the second adjustment member 404. The hole 406 can be spaced from the edge 414 of the bevel 412 by, e.g., in some exemplary embodiments, a distance greater than about 0.1 inch, 0.2 inch, 0.3 inch. 0.5 inch, and ranges encompassing such distances. As shown in FIGS. 13 and 14, the hole 406 is positioned between the edge 414 and the edge 416. In some embodiments, including the illustrated embodiment, the hole 406 is positioned between the first axis 256 and the edge 414.

With continued reference to FIG. 13, the first adjustment member 404 is movable relative to the housing 244 and can include a first end 420 and a second end 422. The first end 420 is configured to protrude from the housing 244 and contact an outwardly facing surface 426 of the fender bracket 240. When the housing 244 and door arm 246 rotate about the first axis 256 in the direction indicated by the arrow 430, the first end 420 contacts the surface 426 thereby stopping the rotation of the housing 244 and door arm 246 about the first axis 256.

The adjustment member 404 preferably has a length suitable for protruding from the housing 244. In some non-limiting exemplary embodiments, the adjustment member 404 has a length of at least about 0.1 inch in order to provide a wide range of adjustment. In some embodiments, the adjustment member 404 has a length of about 0.2 inch or more, 0.3 inch or more, 0.5 inch or more, 0.75 inch or more, or ranges encompassing such lengths. However, the adjustment member 404 can have any suitable length for providing adjustment. A skilled artisan can select the length of the adjustment member 404 to achieve the desired adjustability capabilities.

A tool can rotate the second adjustment member 404 towards or away from the fender bracket 240. The second end 422 of the second adjustment member 404 is preferably provided with a gripping structure 444 for engaging a tool. Any of a variety of gripping structures may be provided in the second end 422. In some embodiments, the gripping structure 444 can be similar or identical to the gripping structure 334 of the first adjustment member 322. Advantageously, a single tool can be conveniently used to manipulate both the first and second adjustment members 322, 404. Alternatively, the gripping structure 444 can be different than the gripping structure 334. For example, the first adjustment member 322 can be a bolt with a slotted gripping structure 334 (i.e., a slotted head), and the second adjustment member 404 can be a screw with a polygonal recessed head 444. A tool in the form of a flat head screw driver can mate with and rotate the first adjustment member 323. A tool in the form of an allen wrench can mate with and rotate the second adjustment member 404.

With continued reference to FIG. 13, the second adjustment member 404 can be moved through the housing 244 to increase or decrease the length of the portion 450 of the second adjustment member 404 protruding from the bevel 412, thereby reducing or increasing, respectively, the angle a (FIG. 9). For example, the second adjustment member 404 can be moved away from the fender bracket 426 to decrease the length of the portion 450 in order to increase the angle a. The second adjustment member 404 can be move through the housing 244 away from the fender bracket 240 until the first end 420 is disposed within the hole 406. The door arm 246 can rotate until the surface of the bevel 412 contacts the outer surface 426. Alternatively, the second adjustment member 404 can be moved towards the fender bracket 426 to increase the length of the portion 450.

In some non-limiting exemplary embodiments, the second adjustment assembly 400 can be operated to provide a range of angle adjustment P. As such, the maximum range of horizontal movement of the door arm 246 can be adjusted. As shown in FIG. 9A, the second adjustment assembly 400 can be manipulated so that the horizontal range of movement of the door arm 246 is limited to angle α₁. The second adjustment assembly 400 can also be adjusted to limit the maximum outward movement of the door arm 246 to a second partially opened position 263 (shown in phantom) to define an angle α₂. The angle of adjustment β, as used herein, is intended to refer to the angle defined between door arm 246 in the first partially opened position 261 and the second partially opened position 263.

In some non-limiting exemplary embodiments, the angle of adjustment β is about 5 degrees or less, more than −5 degrees, 10 degrees or more, 15 degrees or more, 20 degrees or more, 30 degrees or more, 40 degrees or more, 45 degrees or more, 50 degrees or more, 60 degrees or more, and ranges encompassing such angles. In one embodiment, for example, the angle of adjustment β is in the range about 10 degrees to about 45 degrees. The adjustment assembly 400 can be operated to achieve an angle α₂ of about 5 degrees, 20 degrees, 30 degrees, 35 degrees, 40 degrees, and ranges encompassing such degrees. The adjustment assembly 400 can be operated to achieve an angle α₁ of about 10 degrees, 20 degrees, 30 degrees, 35 degrees, 40 degrees, 50 degrees, 60 degrees, and ranges encompassing such degrees.

Advantageously, the adjustable hinge assembly 210 can be adjusted to provide a differently sized opening for differently sized individuals. For example, the angle a can be increased to provide an increased opening suitable for, e.g., a tall individual.

Additionally, the angle a can be selected based on the configuration of the automobile 200. For example, the angle a can be increased or decreased for a narrow or wide automobile, respectively. Further, the door seals of some automobiles can have a shape requiring more clearance for the upward movement of the door. Thus, the angle a can be set so that the door 202 can open without striking the door seals provided on the door 202 or the door opening 212 when the door 202 is moved through the upward motion. Thus, an artisan of ordinary skill can determine the desired angle a (FIG. 9) based on the size of the passengers of the automobile 200, the design of the automobile 200 (e.g., the length of the door 202), and the like.

Providing such an adjustment provides a plurality of further advantages. For example, but without limitation, by providing both adjustment assemblies 213, 400 in the housing 244, the housing 244 can be used with a variety of differently shaped fender and door brackets. As is apparent to one of ordinary skill in the art, the fender and door brackets are shaped to be connectable to a corresponding automobile or a line of automobiles. However, automobiles vary according to manufacturers and model lines, as do the door and fender brackets for such automobiles and model lines of automobiles. Thus, by including both adjustment mechanisms in the housing 244, the housing 244 can be used on different models of hinge mechanisms designed for different automobiles or model lines of automobiles.

With continued reference to FIG. 13, a further advantage is provided where the first adjustment assembly 213 and/or second adjustment assembly 400 are readily accessible. The first adjustment assembly 213 and/or second adjustment assembly 400 can be operated by passing a tool between the fender 446 and the outer body 464 of the automobile. For example, when the door 202 is open and moved upwardly and out of the way, a tool can easily be inserted into the area 462 defined between the housing 244 and the fender 446, and thus into engagement with the second adjustment member 404. Additionally, when the door 202 is open, the first adjustment assembly 213 is also easily accessible.

A further advantage is provided where the second adjustment member 404 is oriented so as to be raked toward the door opening 212. For example, but without limitation, as shown in FIG. 13, the direction of engagement 470 is angled rearwardly relative to the fender 264, and thus is also angled toward to the door opening 212 (not shown). This orientation further eases engagement of the second adjustment member 404 with an adjustment tool.

Because the first adjustment member 322 and/or the second adjustment member 404 are so accessible, a person can quickly apply a significant torque to change the position of the first adjustment member 322 and/or the second adjustment member 404. It is contemplated that the first and second adjustment assemblies 213, 400 can be adjusted with or without the adjustable hinge assembly 210 being mounted to the fender and/or door 202 of the automobile. 200. For example, the first and second adjustment assemblies 213, 400 can be adjusted before the adjustable hinge assembly 210 is mounted to the fender.

The tool used to rotate the first adjustment member 322 and/or the second adjustment member 404 can be a generally straight tool, such as a wrench (e.g., a ratchet wrench), screwdriver (e.g., a flat head screwdriver, Phillips screwdriver, etc.). The tool can also be a curved tool. For example, in one embodiment, the second adjustable member 404 is generally perpendicular to the fender 446 and a tool, preferably a curved tool (e.g., an allen wrench), can rotate the member 404. Additionally, a tool having a universal joint can also be used to reach the second adjustment member 404.

With respect to FIGS. 9 and 13, the housing 244 includes the through-hole 472, hole 406, and hole 330 as discussed above. The housing 244 can be a monolithically formed body that comprises metal (e.g., steel, aluminum, alloys), plastic, ceramic, and/or other suitable material. The housing 244 can optionally comprise a nipple 470 for reducing the frictional interaction between the door arm 246 and the housing 244. The nipple 470 can be in communication with the through-hole 472 via a passage 476. Lubricant can be fed through the nipple 470 and the passage 476 to lubricate the door arm pin 108. The housing 244 includes the through-hole 472, hole 406, and hole 330 as discussed above.

The adjustable hinge assembly 210 can be mounted to hinge mounting holes commonly found on automobiles. For example, the fender bracket 240 and door arm 246 can be mounted onto the original equipment manufacture's (“OEM”) holes, which are normally used to mount conventional door hinges. A skilled artisan can design and size the adjustable hinge assembly 210 for mounting onto various known fender and car door constructions. For example, the door arm and fender bracket 246, 240 can be shaped to conform to known fender and car door constructions. Alternatively, holes can be formed at any suitable location along the fender 446 and/or door 202. Thus, the adjustable hinge assembly 210 can be installed by the OEM or aftermarket by, e.g., an automotive shop.

To install the adjustable hinge assembly 210, the adjustable hinge assembly 210 can be inserted between the fender 446 and the outer body 264. The upper and lower fender mounting plates 50, 52 are then mounted to the frame or reinforced portion of the body of the automobile beneath the fender 446. The door 202 is attached to the door arm 246.

To align the door 202 with the door opening 212, the first adjustment assembly 213 can be operated, preferably while the door 202 is attached to the door arm 246 and spaced from the door opening 212. After the door 202 is properly aligned with the door opening 212, the lock assembly 340 can be adjusted to secure the vertical alignment of the door 202. The second adjustment assembly 400 can be operated to set the distance (i.e., the angle α) that the door 202 can move away from the automobile 200. It is contemplated that the first adjustment assembly 213 and/second adjustment assembly 400 can be operated before, during, and/or after the door 202 is attached to the door arm 246. Also, the adjustable hinge assembly 210 can be mounted to the door 202 before the adjustable hinge assembly 210 is mounted to the fender.

Although not illustrated, the adjustable hinge assembly 210 can be attached at other locations of the automobile 200. For example, the adjustable hinge assembly 210 can be attached to the rearward portion 214 of the door 202 and the fender of the automobile 200 such that the forward portion 215 of the door 202 can be moved away from the door opening 212. The forward portion 215 can be rotated horizontally away from the door opening 212 to a partially opened position. The forward portion 215 can then be rotated upwardly and rearwardly to a fully opened position.

The adjustable hinge assembly 210 can used for various types of motor vehicles, such as sports cars, sedans, sports utility vehicles, vans (including minivans), truck (e.g., a pickup truck), and the like. The adjustable hinge assembly 210 can be hingedly connected to one or more doors of a motor vehicle. For example, four adjustable hinge assemblies 210 can be mounted to four corresponding doors of a sedan.

In some embodiments, a kit is provided that comprises the adjustable hinge assembly 310. The kit can also include packaging, one or more installation tools (e.g., a wrench), fasteners, and/or instructions (e.g., manual describing an installation procedure).

An artisan of ordinary skill will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. Additionally, the methods which is described and illustrated herein is not limited to the exact sequence of acts described, nor is it necessarily limited to the practice of all of the acts set forth. Other sequences of events or acts, or less than all of the events, or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein. Thus, it will be appreciated by those skilled in the art that various modifications and changes may be made without departing from the scope of the invention, and all such modifications and changes are intended to fall within the scope of the invention, as defined by the appended claims.

What is claimed is:

1. A hinge for a motor vehicle, comprising:
a mounting bracket configured to be mounted to a portion of motor vehicle that remains stationary relative to a door of the vehicle;
a door arm configured to be mounted to the door of the motor vehicle;
a housing connecting the door arm to the fender bracket and defining a first pivot axis and a second pivot axis;
a first adjustment member received within and movable relative to the housing and configured to limit the rotation of the door arm about the second pivot axis towards the fender bracket; and
a second adjustment member movable relative to the housing and having a first end configured to contact the fender bracket when the door arm is rotated about the first pivot axis through a predetermined angle relative to the fender bracket, the second adjustment member having an opposing second end extending generally towards the door arm, the second end being exposed to an exterior of the housing.

2. The hinge for a motor vehicle of claim 1, wherein the second adjustment member is moveable between a first position and a second position to define a plurality of said predetermined angles.

3. The hinge for a motor vehicle of claim 1, wherein the housing comprises a first hole configured to receive the first adjustment member and a second hole configured to receive the second adjustment member.

4. The hinge for a motor vehicle of claim 3, wherein the first and the second adjustment members have external threads configured to mate with internal threads of the corresponding first and second holes.

5. The hinge for a motor vehicle of claim 1, wherein the first adjustment member and the second adjustment member are accessible to engage a tool passed between the housing and an outer body panel of the motor vehicle.

6. The hinge for a motor vehicle of claim 1, wherein the first axis is generally vertically orientated and the second axis is generally horizontally oriented when the motor vehicle is on horizontal surface.

7. A hinge for a motor vehicle, comprising:
a fender bracket configured to be mounted to a portion of a motor vehicle adjacent to a door opening of the motor vehicle;
a door arm configured to be mounted the door of the motor vehicle;
a hinge assembly connecting the door arm to the fender bracket, the hinge assembly defining a first pivot axis and a second pivot axis, the hinge assembly and the door arm connected such that the door arm can rotate about the first pivot axis between a first position and a second position, and about the second pivot axis between a third position and a fourth position;
a first adjustment assembly configured to selectively determine at least the maximum limit of the angle between the first position and the second position; and
a second adjustment assembly configured to selectively determine the maximum limit of the angle between the third position and the fourth position.

8. The hinge for the motor vehicle of claim 7, wherein the first adjustment assembly comprises a first adjustment member, the first adjustment member extends towards the door arm and is configured to receive a tool adapted to move the first adjustment member.

9. The hinge for the motor vehicle of claim 7, wherein the second adjustment assembly comprises a second adjustment member, the second adjustment member extends towards the door arm and is configured to receive a tool adapted to move the second adjustment member.

10. The hinge for the motor vehicle of claim 7, wherein the hinge assembly and the door arm rotate together about the first pivot axis between the first position and a second position.

11. The hinge for the motor vehicle of claim 7, wherein the door arm is in the first position when the hinge holds a door of a vehicle in a closed position.

12. The hinge for the motor vehicle of claim 7, wherein the second adjustment assembly is moveable between a first adjustment position and a second adjustment position to define an angle of adjustment of at least about 5 degrees.

13. The hinge for the motor vehicle of claim 7, wherein the second adjustment assembly is moveable between a first adjustment position and a second adjustment position to define an angle of adjustment of at least about 10 degrees.

14. A hinge for a motor vehicle, comprising:
a fender bracket configured to be mounted to a portion of a motor vehicle adjacent to a door opening of the motor vehicle;
a door arm configured to be mounted a door of a motor vehicle;
a hinge assembly connecting the door arm to the fender bracket, the hinge assembly defining a first pivot axis and a second pivot axis, the hinge assembly and the door arm connected such that the door arm can rotate about the first pivot axis between a first position and a second position, and about the second pivot axis relative to the housing between a third position and a fourth position; and
means for selectively determining the maximum limit of the angle between the first position and the second position and the maximum limit of the angle between the third position and the fourth position.
